(19) United States
(12) Patent Application Publication
(10) Pub. No.: US 2014/0047094 A1
(43) Pub. Date: Feb. 13, 2014

(54) Method and apparatus for personal-network merging and splitting

(71) Applicants: Lizhe Yao, Shenzhen (CN); Jun Chen, Shenzhen (CN); Guoqiang Shang, Shenzhen (CN)

(72) Inventors: Lizhe Yao, Shenzhen (CN); Jun Chen, Shenzhen (CN); Guoqiang Shang, Shenzhen (CN)

(73) Assignee: ZTE CORPORATION, Shenzhen, Guangdong (CN)

(21) Appl. No.: 14/112,706

(22) PCT Filed: Mar. 22, 2012
(86) PCT No.: PCT/CN2012/072845

§ 371 Date: Oct. 18, 2013

(30) Foreign Application Priority Data
Apr. 25, 2011 (CN) 201110103957.5

(51) Int. Cl. H04L 12/24

(52) U.S. Cl. CPC H04L 41/00
USPC 709/223

(57) ABSTRACT

The embodiments of the present disclosure disclose technical solutions for a method and apparatus for personal-network merging and splitting, wherein the method for personal-network merging includes that: a user, a server, a service, a personal network device, a personal network gateway or a particular event triggers a personal-network merging; a new personal network gateway is selected for a merged personal network; a personal network device is enrolled in the merged personal network; and the merged personal network is registered on a personal network server. The method for personal-network splitting includes that: a user, a server, a service, a personal network device, a personal network gateway or a particular event triggers a personal-network splitting; a new personal network gateway is selected for a personal network after the splitting; personal network devices are enrolled in personal networks after the splitting respectively; and the personal networks after the splitting are registered on a personal network server. With the method and apparatus of the present disclosure, the problem of personal area network (PN) merging and splitting and in particular merging and splitting of multiple personal networks in a PN can be solved effectively when there are a large number of PNs.

### TECHNICAL FIELD

The disclosure relates to network merging and splitting techniques, and in particular to a method and apparatus for personal-network merging and splitting.

### BACKGROUND

With the development of science and techniques, people possess more and more personal devices, such as a mobile phone, a laptop, a PDA, an MP3, an MP4 and so on, with increasing capabilities; and most of the devices are capable of short-range communication; therefore there is an increasing desire for these devices around people to be connected together into a personal area network (PN) to share a resource and a capability of each other.

FIG. 1 shows a schematic diagram of networking among various devices in a PN including personal network devices, personal network gateways, and a personal network server, a networking relationship thereamong being that: a personal network 1 consists of a personal network gateway 1, a personal network device 1 and a personal network device 2; a personal network 2 consists of a personal network gateway 2, the personal network device 2 and a personal network device 3; a personal network 3 consists of a personal network gateway 3, the personal network device 3 and a personal network device 4; a personal network 4 consists of a personal network gateway 4, a personal network device 5, a personal network device 6, a personal network device 7 and a personal network device 8. Each personal network is connected to the personal network server through the personal network gateway of the personal network; and in FIG. 1, the personal network device 2 belongs to both the personal network 1 and the personal network 2, and the personal network device 3 belongs to both the personal network 2 and the personal network 3.

However, as such PNs continue to increase in number, how to manage these PNs effectively, and in particular, how to merge and split multiple personal networks in a PN, has become an imperative problem. There is no effective solution yet regarding the problem of merging and splitting of multiple personal networks at present.

### SUMMARY

In view of the above, the main purpose of the embodiments in the present disclosure is to provide a method and apparatus for personal-network merging and splitting capable of effectively solving the problem of personal area network (PN) merging and splitting and in particular merging and splitting of multiple personal networks in a PN when there are a large number of PNs.

To achieve the above purpose, a technical solution of the embodiments in the present disclosure is implemented as follows.

A method for personal-network merging includes:

triggering a personal-network merging by a user, a server, a service, a personal network device, a personal network gateway, or a particular event;

selecting a new personal network gateway for a merged personal network from all members of two or more personal networks before the merging;

enrolling a personal network device in the merged personal network; and

registering the merged personal network on a personal network server.

The method may further include: after the triggering a personal-network merging,

sending, by a personal network gateway or a personal network device in a personal network that is triggered to initiate the merging, a personal-network-merging request to a respective personal network gateway of another personal network to invite the another personal network to merge; returning, by the respective personal network gateway that receives the personal-network-merging request, to the personal network gateway or the personal network device that initiates the invitation a response indicating whether the another personal network agrees to merge, wherein

when the triggering a personal-network merging is initiated by the user or the server, then by default each device to be involved in the merging agrees to merge.

The selecting a new personal network gateway for a merged personal network from all members of two or more personal networks before the merging may be: selecting the new personal network gateway for the merged personal network from personal network gateways of the two or more personal networks before the merging.

The enrolling a personal network device in the merged personal network may include:

when the new personal network gateway after the merging and the personal network device belong to a same personal network before the merging, and the new personal network gateway is also the personal network gateway of the same personal network before the merging, then the personal network device already belongs to the merged personal network and is spared from being re-enrolled in the merged personal network; and

when the new personal network gateway after the merging and the personal network device don't belong to a same personal network before the merging, then the personal network device needs to send the new personal network gateway after the merging a request for being enrolled in the merged personal network.

The registering the merged personal network on a personal network server may include:

registering, by the new personal network gateway after the merging, the merged personal network on the personal network server; and storing, by the personal network server, information on the merged personal network.

An apparatus for personal-network merging located in a personal network gateway includes a merging triggering unit, a gateway selecting unit, and a post-merging enrolling unit, wherein

the merging triggering unit is configured to trigger a personal-network merging by a user, a server, a service, a personal network device, a personal network gateway, or a particular event;

the gateway selecting unit is configured to select a new personal network gateway for a merged personal network from all members of two or more personal networks before the merging; and

the post-merging enrolling unit is configured to enroll a personal network device in the merged personal network.

The apparatus may further include

a merging responding unit configured to, when the personal-network merging is triggered, cause a personal network gateway or a personal network device in a personal network that is triggered to initiate the merging to send a personal-network-merging request to a respective personal network gateway of another personal network to invite the another personal network to merge, and cause the respective personal network gateway that receives the personal-network-merging request to return to the personal network gateway or the personal network device that initiates the invitation a response indicating whether the another personal network agrees to merge, wherein

when the triggering of the personal-network merging is initiated by the user or the server, then by default each device to be involved in the merging agrees to merge.

An apparatus for personal-network merging located in a personal network server includes a merging triggering unit, a gateway selecting unit, a post-merging enrolling unit, and a first registering unit, wherein

the merging triggering unit is configured to trigger a personal-network merging by a user, a server, a service, a personal network device, a personal network gateway, or a particular event;

the gateway selecting unit is configured to select a new personal network gateway for a merged personal network from all members of two or more personal networks before the merging;

the post-merging enrolling unit is configured to enroll a personal network device in the merged personal network; and

the first registering unit is configured to register the merged personal network on the personal network server.

A method for personal-network splitting includes:

triggering a personal-network splitting by a user, a server, a service, a personal network device, a personal network gateway, or a particular event;

selecting a new personal network gateway for a personal network after the splitting from all members of a personal network before the splitting;

enrolling personal network devices in personal networks after the splitting, respectively; and

registering the personal networks after the splitting on a personal network server.

The method may further include: after the triggering a personal-network splitting,

sending, by the personal network gateway or a personal network device in the personal network that is triggered to initiate the splitting, a personal network splitting request to another respective selected personal network gateway of a personal network after the splitting; returning, by the another respective selected personal network gateway that receives the personal network splitting request, to the personal network gateway or the personal network device that initiates the splitting request a response indicating whether to agree to split, wherein

when the triggering a personal-network splitting is initiated by the user or the server, then by default each device to be involved in the splitting agrees to split.

The enrolling personal network devices in personal networks after the splitting, respectively may include:

when a personal network device to be enrolled in a personal network after the splitting and the new personal network gateway of the personal network after the splitting belong to a same personal network before the splitting, and the new personal network gateway is also the personal network gateway of the personal network before the splitting, then the personal network device already belongs to the personal network after the splitting and is spared from being re-enrolled in the personal network after the splitting; and

when a personal network device to be enrolled in a personal network after the splitting and the new personal network gateway of the personal network after the splitting don't belong to a same personal network before the splitting, then the personal network device needs to send the new personal network gateway after the splitting a request for being enrolled in the personal network after the splitting.

The registering the personal networks after the splitting on a personal network server may include:

registering, by a new personal network gateway of a personal network after the splitting, the personal network after the splitting on the personal network server; and storing, by the personal network server, information on the personal network after the splitting.

An apparatus for personal-network splitting located in a personal network gateway includes a splitting triggering unit, a gateway selecting unit, and a post-splitting enrolling unit, wherein

the splitting triggering unit is configured to trigger a personal-network splitting by a user, a server, a service, a personal network device, a personal network gateway, or a particular event;

the gateway selecting unit is configured to select a new personal network gateway for a personal network after the splitting, including selecting the new personal network gateway after the splitting from all members of a personal network before the splitting;

the post-splitting enrolling unit is configured to enroll personal network devices in personal networks after the splitting, respectively.

The apparatus may further include a splitting responding unit configured to, when the personal-network splitting is triggered, cause the personal network gateway or a personal network device in the personal network that is triggered to initiate the splitting to send a personal network splitting request to another respective selected personal network gateway of a personal network after the splitting, and cause the another respective selected personal network gateway that receives the personal network splitting request to return to the personal network gateway or the personal network device that initiates the splitting request a response indicating whether to agree to split, wherein when the triggering of the personal-network splitting is initiated by the user or the server, then by default each device to be involved in the splitting agrees to split.

An apparatus for personal-network splitting located in a personal network server include a splitting triggering unit, a gateway selecting unit, a post-splitting enrolling unit, and a second registering unit, wherein

the splitting triggering unit is configured to trigger a personal-network splitting by a user, a server, a service, a personal network device, a personal network gateway, or a particular event;

the gateway selecting unit is configured to select a new personal network gateway for a personal network after the splitting, including selecting the new personal network gateway after the splitting from all members of a personal network before the splitting;

the post-splitting enrolling unit is configured to enroll personal network devices in personal networks after the splitting, respectively; and

the second registering unit is configured to register the personal networks after the splitting on the personal network server.

The merging solution in the embodiments of the present disclosure mainly includes that: a personal-network merging is triggered by a user, a server, a service, a personal network device, a personal network gateway, or a particular event; a new personal network gateway is selected for a merged personal network from all members of two or more personal networks before the merging; a personal network device is enrolled in the merged personal network; and the merged personal network is registered on a personal network server. The splitting solution in the embodiments of the present disclosure mainly includes that: a personal-network splitting is triggered by a user, a server, a service, a personal network device, a personal network gateway, or a particular event; a new personal network gateway is selected for a personal network after the splitting from all members of a personal network before the splitting; and personal network devices are enrolled in personal networks after the splitting, respectively. With the embodiments of the present disclosure, the problem of merging and splitting of multiple personal networks is solved effectively.

### BRIEF DESCRIPTION OF THE DRAWINGS

FIG. 1 is a schematic diagram of networking among various devices in a PN in an existing technique;

FIG. 2 is a flow chart of the basic principle of a method for personal-network merging of an embodiment in the present disclosure;

FIG. 3 is a flow chart of the basic principle of a method for personal-network splitting of an embodiment in the present disclosure;

FIG. 4 is a schematic diagram of the networking of an embodiment 1 in the present disclosure;

FIG. 5 is a schematic diagram of the networking of an embodiment 2 in the present disclosure; and

FIG. 6 is a schematic diagram of the networking of an embodiment 3 in the present disclosure.

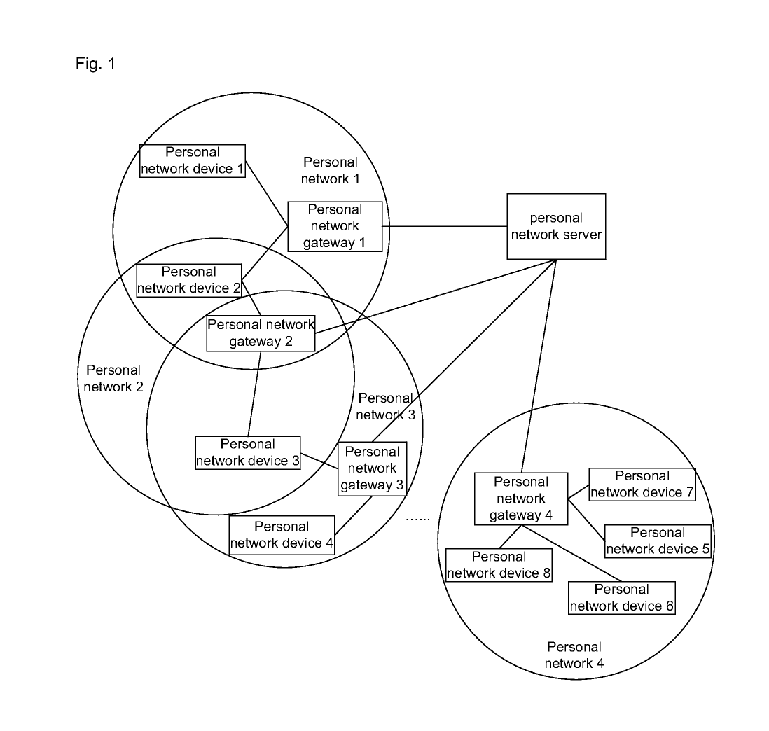

### DETAILED DESCRIPTION

According to various embodiments of the present disclosure, a merging solution mainly includes that: a user, a server, a service, a personal network device, a personal network gateway, or a particular event triggers a personal-network merging; a new personal network gateway is selected for a merged personal network from all members of two or more personal networks before the merging; a personal network device is enrolled in the merged personal network; and the merged personal network is registered on a personal network server; and a splitting solution mainly includes that: a user, a server, a service, a personal network device, a personal network gateway, or a particular event triggers a personal-network splitting; a new personal network gateway is selected for a personal network after the splitting from all members of a personal network before the splitting; and personal network devices are enrolled in personal networks after the splitting, respectively.

The implementation of the technical solutions will be further elaborated below with reference to the accompanying drawings.

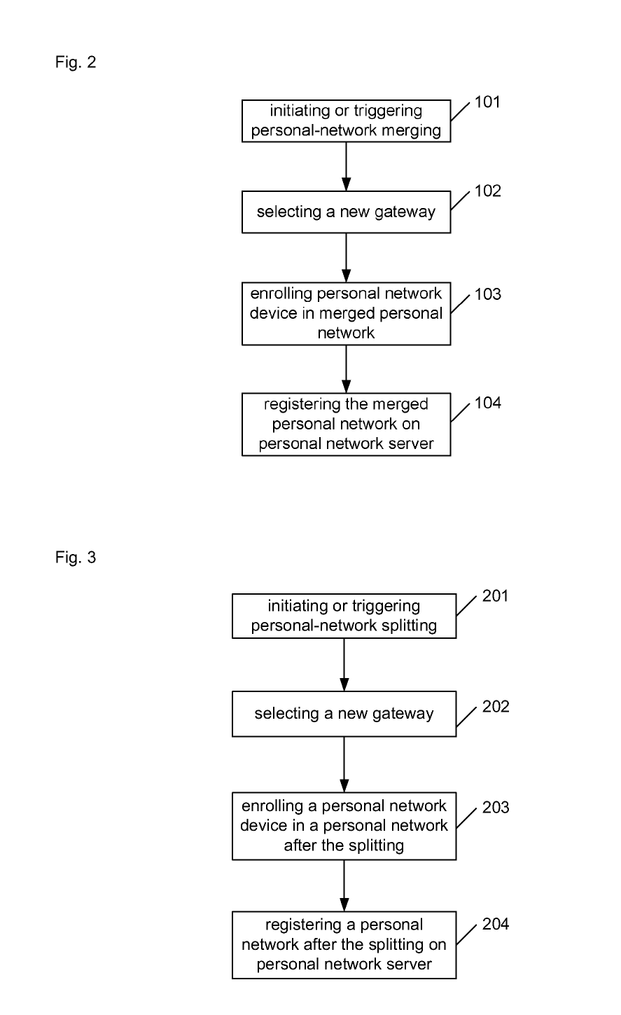

A method for personal-network merging, a flow of the basic principle of which being as shown in FIG. 2, mainly includes the following steps:

Step 101, a personal-network merging may be initiated or triggered by a user, a server, a service, a personal network device, a personal network gateway, or a certain particular event. In the case of the merging, the “particular event” includes that the user enters a particular area, for example, a house, a car, a hotel and so on, which will not be elaborated here.

Here, the merging may be merging of two personal networks into one new personal network, or merging of multiple personal networks into one new personal network. A personal network gateway or a personal network device in a personal network that is triggered to initiate the merging sends a personal-network-merging request to a respective personal network gateway of another personal network to invite the another personal network to merge; the respective personal network gateway that receives the personal-network-merging request returns to the personal network gateway or the personal network device that initiates the invitation a response indicating whether the another personal network agrees to merge. When the merging is initiated by the user or the server, then by default each of the members agrees to merge. Here, the members refer to all devices in the two or more personal networks to be merged.

Step 102, a new personal network gateway is selected for a merged personal network.

Here, selecting the new personal network gateway for the merged personal network mainly includes that:

A1, first, the new personal network gateway of the merged personal network may be selected from personal network gateways of the two or more personal networks before the merging, or from all members of the two or more personal networks before the merging. Selection from all the members means selection of the new personal network gateway from both the personal network gateways and personal network devices.

B1, secondly, the new personal network gateway of the merged personal network may be selected by the user, the server, the service, or another third party (such as a CP or an SP).

C1, next, there may be multiple standards for selecting the new personal network gateway of the merged personal network, for example, selecting randomly, selecting according to a device capability, selecting according to a service type and so on. Here, regarding the device capability, both the personal network device and the personal network gateway are logical entities, which may exist in a specific physical device (such as a mobile phone), therefore the device capability mentioned herein refers to a capability of a physical device in which such a logical entity is located, which will be not elaborated here.

Step 103, a personal device is enrolled in the merged personal network.

Here, enrolling the personal device in the merged personal network mainly includes that:

A2, when the new personal network gateway after the merging and the personal network device belong to a same personal network before the merging, and the new personal network gateway is also the personal network gateway of the same personal network before the merging, then the personal network device already belongs to the merged personal network and is spared from being re-enrolled in the merged personal network.

B2, when the new personal network gateway after the merging and the personal network device don't belong to a same personal network before the merging, then the personal network device needs to send the new personal network gateway after the merging a request for being enrolled in the merged personal network.

Here, there are two cases when the personal network device sends the new personal network gateway after the merging a request for being enrolled in the merged personal network: in the first case, if there is an established link between the new personal network gateway after the merging and the personal network device, then the personal network device requests to be enrolled in the merged personal network directly; in the second case, if no link is established between the new personal network gateway after the merging and the personal network device, then a link needs to be established between the new personal network gateway after the merging and the personal network device before the personal network device requests to be enrolled in the merged personal network.

C2, if a personal network gateway of a personal network before the merging is selected as the new personal network gateway of the merged personal network, then the personal network gateway before the merging may continue to exist as the personal network gateway after the merging; otherwise the personal network gateway before the merging may be enrolled in the merged personal network as a personal network device (in which case the personal network gateway before the merging is required to switch to a personal network device mode), or leave the merged personal network directly.

Step 104, the merged personal network is registered on a personal network server.

Here, registering the merged personal network on the personal network server mainly includes that: the new personal network gateway after the merging registers the merged personal network on the personal network server; and the personal network server stores information on the merged personal network.

With an apparatus for personal-network merging, one solution is that the apparatus is located in a personal network gateway, the other is that the apparatus is located in a personal network server; both solutions are described below, respectively.

An apparatus for personal-network merging is located in a personal network gateway, the apparatus including a merging triggering unit, a gateway selecting unit, a post-merging enrolling unit. Wherein, the merging triggering unit is configured to trigger a personal-network merging by a user, a server, a service, a personal network device, a personal network gateway, or a particular event. The gateway selecting unit is configured to select a new personal network gateway for a merged personal network from all members of two or more personal networks before the merging. The post-merging enrolling unit is configured to enroll a personal network device in the merged personal network.

Here, the apparatus also includes a merging responding unit configured to, when the personal-network merging is triggered, cause a personal network gateway or a personal network device in a personal network that is triggered to initiate the merging to send a personal-network-merging request to a respective personal network gateway of another personal network to invite the another personal network to merge, and cause the respective personal network gateway that receives the personal-network-merging request to return to the personal network gateway or the personal network device that initiates the invitation a response indicating whether the another personal network agrees to merge, wherein when the triggering of the personal-network merging is initiated by the user or the server, then by default each device to be involved in the merging agrees to merge.

Here, the post-merging enrolling unit is also configured as such: when the new personal network gateway after the merging and the personal network device belong to a same personal network before the merging, and the new personal network gateway is also the personal network gateway of the same personal network before the merging, then the personal network device already belongs to the merged personal network and is spared from being re-enrolled in the merged personal network; when the new personal network gateway after the merging and the personal network device don't belong to a same personal network before the merging, then the personal network device needs to send the new personal network gateway after the merging a request for being enrolled in the merged personal network.

An apparatus for personal-network merging is located in a personal network server, the apparatus including a merging triggering unit, a gateway selecting unit, a post-merging enrolling unit, and a first registering unit. Wherein, the merging triggering unit is configured to trigger a personal-network merging by a user, a server, a service, a personal network device, a personal network gateway, or a particular event. The gateway selecting unit is configured to select a new personal network gateway for a merged personal network from all members of two or more personal networks before the merging. The post-merging enrolling unit is configured to enroll a personal network device in the merged personal network. The first registering unit is configured to register the merged personal network on the personal network server.

A method for personal-network splitting, a flow of the basic principle of which being as shown in FIG. 3, mainly includes the following steps:

Step 201, a personal-network splitting may be initiated or triggered by a user, a server, a service, a personal network device, a personal network gateway, or a certain particular event. In the case of the splitting, the “particular event” includes that the user leaves a particular area, for example, a house, a car, a hotel and so on, which will not be elaborated here.

Here, the splitting may be splitting of one personal network into two new personal networks, or splitting of one personal network into multiple new personal networks. The personal network gateway or a personal network device in the personal network that is triggered to initiate the splitting sends a personal network splitting request to another respective selected personal network gateway of a personal network after the splitting; the another respective selected personal network gateway that receives the personal network splitting request returns to the personal network gateway or the personal network device that initiates the splitting request a response indicating whether to agree to split. When the splitting is initiated by the user or the server, then by default each of the members agrees to split. Here, the members refer to all devices in one personal network to be split.

Step 202, a new personal network gateway is selected for each personal network after the splitting.

Here, selecting the new personal network gateway for each personal network after the splitting mainly includes that:

A3, first, a new personal network gateway of a personal network after the splitting may be selected from all members of the personal network before the splitting, in other words, a new personal network gateway of a personal network after the splitting may be selected from both the personal network gateway before the splitting and personal network devices before the splitting.

B3, secondly, a new personal network gateway of a personal network after the splitting may be selected by the user, the server, the service, or another third party.

C3, next, there may be multiple standards for selecting a new personal network gateway of a personal network after the splitting, for example, selecting randomly, selecting according to a device capability, selecting according to a service type and so on.

D3, if a device (a personal network gateway or a personal network device) selected as a new personal network gateway of a personal network after the splitting, is currently not in a personal network gateway state, then the device selected as a new personal network gateway of a personal network after the splitting is required to switch to a personal network gateway mode.

Step 203, personal network devices are enrolled in personal networks after the splitting, respectively.

Here, enrolling a personal devices in a personal network after the splitting mainly includes that:

A4, when the personal network device to be enrolled in the personal network after the splitting and the new personal network gateway of the personal network after the splitting belong to the same personal network before the splitting, and the new personal network gateway after the splitting is also the personal network gateway of the personal network before the splitting, then the personal network device already belongs to the personal network after the splitting and is spared from being re-enrolled in the personal network after the splitting.

B4, when the personal network device to be enrolled in the personal network after the splitting and the new personal network gateway of the personal network after the splitting don't belong to a same personal network before the splitting, then the personal network device needs to send the new personal network gateway after the splitting a request for being enrolled in the personal network after the splitting.

Here, there are two cases when a personal network device sends a new personal network gateway of a personal network after the splitting a request for being enrolled in the personal network after the splitting: in the first case, if there is an established link between the personal network device and the new personal network gateway after the splitting, then the personal network device requests to be enrolled in the personal network after the splitting directly; in the second case, if no link is established between the personal network device and the new personal network gateway after the splitting, then a link needs to be established between the personal network device and the new personal network gateway after the splitting before the personal network device requests to be enrolled in the personal network after the splitting.

Step 204, the personal networks after the splitting are registered on a personal network server.

Here, registering each of the personal networks after the splitting on the personal network server mainly includes that: a new personal network gateway of a personal network after the splitting registers the personal network after the splitting on the personal network server; and the personal network server stores information on the personal network after the splitting.

It should be noted that for either merging or splitting, a state before the personal-network merging or splitting may be remembered so that the previous state may be referenced at the time of a next merging or splitting. The state may be stored on the personal network server or a personal network gateway. The state includes a device currently included in a personal network as well as a current state (for example, on-line, off-line, or busy state, and a service in use) of such a device.

With an apparatus for personal-network splitting, one solution is that the apparatus is located in a personal network gateway, the other is that the apparatus is located in a personal network server; both solutions are described below, respectively.

An apparatus for personal-network splitting is located in a personal network gateway, the apparatus including a splitting triggering unit, a gateway selecting unit, and a post-splitting enrolling unit. Wherein, the splitting triggering unit is configured to trigger a personal-network splitting by a user, a server, a service, a personal network device, a personal network gateway, or a particular event. The gateway selecting unit is configured to select a new personal network gateway for a personal network after the splitting, including selecting the new personal network gateway after the splitting from all members of a personal network before the splitting. The post-splitting enrolling unit is configured to enroll personal network devices in personal networks after the splitting, respectively.

Here, the apparatus also includes a splitting responding unit configured to, when the personal-network splitting is triggered, cause the personal network gateway or a personal network device in the personal network that is triggered to initiate the splitting to send a personal network splitting request to another respective selected personal network gateway of a personal network after the splitting, and cause the another respective selected personal network gateway that receives the personal network splitting request to return to the personal network gateway or the personal network device that initiates the splitting request a response indicating whether to agree to split, wherein when the triggering of the personal-network splitting is initiated by the user or the server, then by default each device to be involved in the splitting agrees to split.

An apparatus for personal-network splitting is located in a personal network server, the apparatus including a splitting triggering unit, a gateway selecting unit, a post-splitting enrolling unit, and a second registering unit. Wherein, the splitting triggering unit is configured to trigger a personal-network splitting by a user, a server, a service, a personal network device, a personal network gateway, or a particular event. The gateway selecting unit is configured to select a new personal network gateway for a personal network after the splitting, including selecting the new personal network gateway after the splitting from all members of a personal network before the splitting. The post-splitting enrolling unit is configured to enroll personal network devices in personal networks after the splitting, respectively. The second registering unit is configured to register the personal networks after the splitting on the personal network server.

Here, the second registering unit is further configured for registering, by a new personal network gateway of a personal network after the splitting, the personal network after the splitting on the personal network server; and for storing, by the personal network server, information on the personal network after the splitting.

Embodiments of the present disclosure are elaborated as follows.

### A Specific Embodiment 1

User A has two personal networks simultaneously, namely a personal network 1 supporting a video service and a personal network 2 supporting a voice service, respectively.

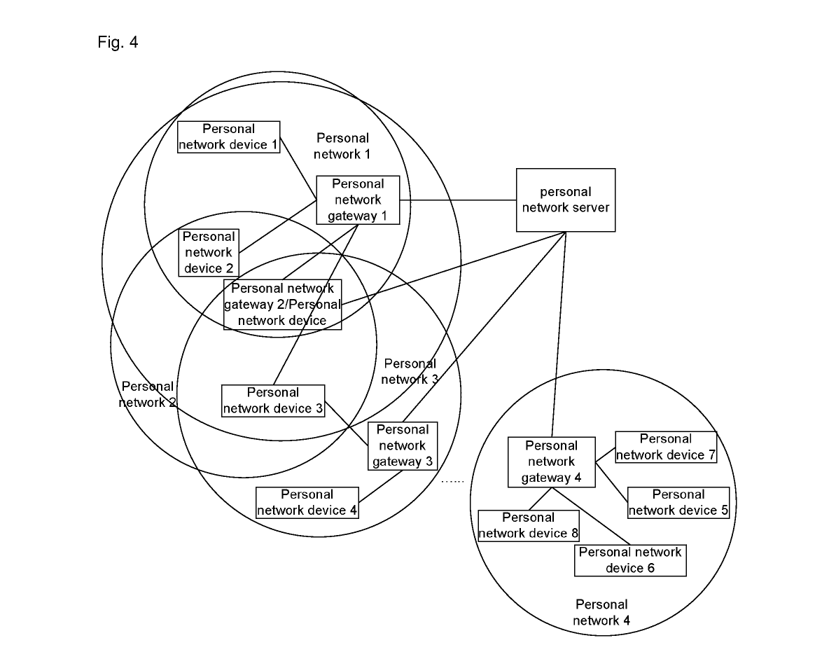

The user A wishes to merge personal networks 1, 2 into one personal network to support a video call service; a schematic diagram of the networking is as shown in FIG. 4, and the flow includes:

b1, use A initiates a merging of the two personal networks into one new personal network. A triggered personal network gateway 1 sends a personal-network-merging request to a personal network gateway 2 of personal network 2 that is invited to merge; the personal network gateway 2 returns a response to the personal network gateway 1 to agree to merge.

b2, a new personal network gateway is selected for the merged personal network; the user A selects the personal network gateway 1 (supporting a 3G network) as the new personal network gateway after the merging according to a capability of each device in the two personal networks.

b3, a personal network device is enrolled in the merged personal network.

Here, a personal network device 1, a personal network device 2 and the personal network gateway 1 after the merging belong to the same personal network 1 before the merging, and the personal network gateway 1 is also the personal network gateway of the personal network 1 before the merging, therefore the personal network device 1 and the personal network device 2 already belong to the merged personal network and are spared from being re-enrolled in the merged personal network. However, a personal network device 3 needs to send the personal network gateway 1 after the merging a request for being enrolled in the merged personal network. The specific process is that: the personal network device 3 and the personal network gateway 1 first discover each other and establish a link with each other; the personal network device 3 sends the personal network gateway 1 a request for being enrolled in the merged personal network.

The personal network gateway 2 is converted into a personal network device and sends the personal network gateway 1 a request for being enrolled in the merged personal network.

b4, the merged personal network is registered on the personal network server.

Here, the personal network gateway 1 registers the merged personal network on the personal network server, and the personal network server stores information on the merged personal network.

### A Specific Embodiment 2

User A has a personal network 1, user B has a personal network 2, and user C has a personal network 3.

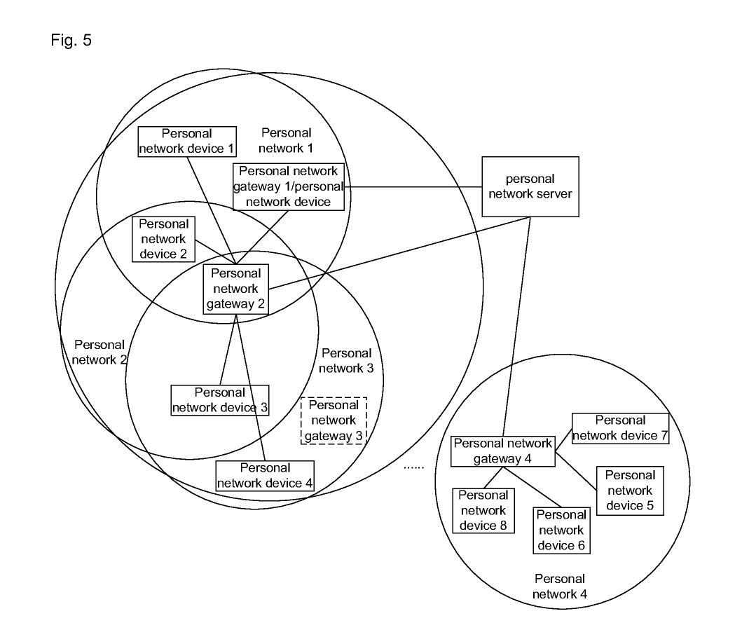

The users A, B and C get together and wish to merge their personal networks into one new personal network to share content; a schematic diagram of the networking is as shown in FIG. 5, and the flow includes:

c1, use A initiates the merging of the three personal networks into one new personal network. A triggered personal network gateway 1 sends a personal-network-merging request to a personal network gateway 2 and a personal network gateway 3 that are invited to merge; personal network gateway 2 returns a response to the personal network gateway 1 to agree to merge; and personal network gateway 3 returns a response to the personal network gateway 1 to agree to merge.

c2, a new personal network gateway is selected for the merged personal network; a personal network server randomly selects the personal network gateway 2 as the new personal network gateway of the merged personal network.

c3, a personal network device is enrolled in the merged personal network.

Here, a personal network device 2, a personal network device 3 and the personal network gateway 2 after the merging belong to the same personal network 2 before the merging, and the personal network gateway 2 is also the personal network gateway of the personal network 2 before the merging, therefore the personal network device 2 and the personal network device 3 already belong to the merged personal network and are spared from being re-enrolled in the merged personal network.

Meanwhile, a personal network device 1 and a personal network device 4 need to send the personal network gateway 2 after the merging a request for being enrolled in the merged personal network. The specific process is that: the personal network device 1, the personal network device 4 and the personal network gateway 2 first discover each other and establish a link with each other; the personal network device 1 and the personal network device 4 send the personal network gateway 2 a request for being enrolled in the merged personal network, respectively.

The personal network gateway 1 is converted into a personal network device and sends the personal network gateway 2 a request for being enrolled in the merged personal network.

A personal network gateway 3 leaves the merged personal network.

c4, the merged personal network is registered on the personal network server.

Here, the personal network gateway 2 registers the merged personal network on the personal network server, and the personal network server stores information on the merged personal network.

### A Specific Embodiment 3

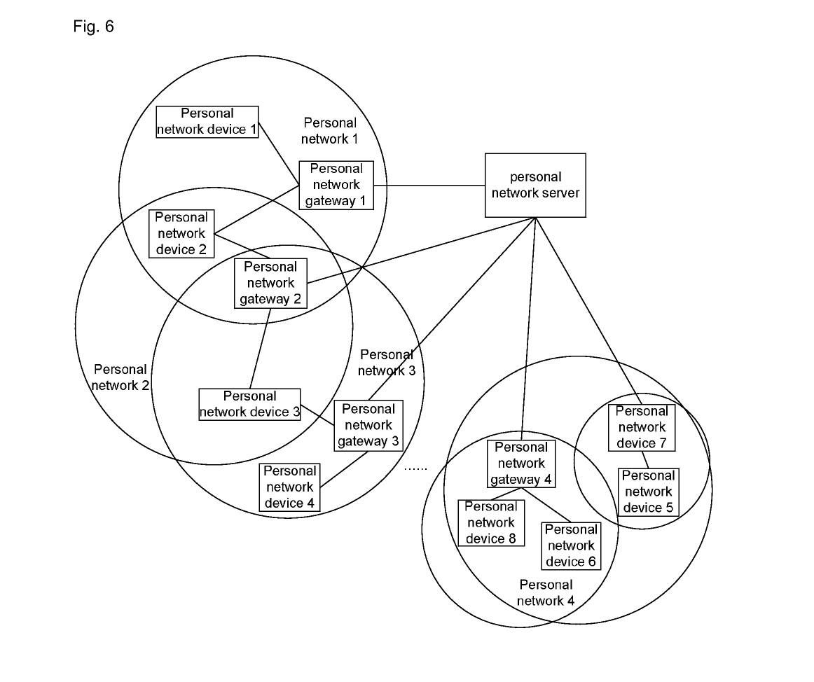

There is a personal network 4 in a user A's house, personal network 4 including a personal network gateway 4, a personal network device 5, a personal network device 6, a personal network device 7 and a personal network device 8. The user A wishes to split the personal network into two different personal networks, one being left at home and the other is carried out with user A; a schematic diagram of the networking is as shown in FIG. 6, and the flow includes:

d1, use A initiates a, splitting of the personal network 4 into two different personal networks, namely one personal network formed by personal network gateway 4, personal network device 6, and personal network device 8, with the personal network gateway 4 as a new personal network gateway; and the other personal network formed by personal network device 7 and personal network device 5, with personal network device 7 as a new personal network gateway, respectively.

d2, a new personal network gateway is selected for each of the two personal networks after the splitting.

Here, the specific process of selecting the new personal network gateways is that: the user A selects the personal network gateway 4 and the personal network device 7 as the new personal network gateways after the splitting; the triggered personal network gateway 4 sends a personal network splitting request to the new personal network gateway (the personal network device 7) of one of the personal networks after the splitting, the personal network device 7 returns a response to the personal network gateway 4 to indicate whether to agree to split; if the personal network device 7 is currently not in a personal network gateway state, then the state of personal network device 7 is switched to a personal network gateway mode.

d3, a personal network device is enrolled in a personal network after the splitting.

Here, the specific process of enrollment is that: the personal network device 6, the personal network device 8 and the personal network gateway 4 after the splitting belong to the same personal network before the splitting, and the personal network gateway 4 is also the personal network gateway of the personal network before the splitting, then the personal network device 6 and the personal network device 8 already belong to a personal network after the splitting and are spared from being re-enrolled in the personal network after the splitting; However, the personal network device 5 needs to send a new personal network gateway (the personal network device 7) of a personal network after the splitting a request for being enrolled in the personal network after the splitting.

Here, the specific process that the personal network device 5 sends the new personal network gateway (the personal network device 7) of a personal network after the splitting a request for being enrolled in the personal network after the splitting is that: the personal network device 5 and the new personal network gateway (the personal network device 7) establish a link with each other; the personal network device 5 sends the new personal network gateway (the personal network device 7) a request for being enrolled in the personal network after the splitting.

d4, each of the personal networks after the splitting is registered on the personal network server.

Here, the personal network gateway 4 and the personal network device 7 (now being a new personal network gateway) register the personal networks after the splitting on the personal network server, and the personal network server stores information on the personal networks after the splitting.

What described are merely preferred embodiments of the present disclosure, and are not intended to limit the protection scope of the present disclosure.

1. A method for personal-network merging, comprising:
triggering a personal-network merging by a user, a server, a service, a personal network device, a personal network gateway, or a particular event;
selecting a new personal network gateway for a merged personal network from all members of two or more personal networks before the merging;
enrolling a personal network device in the merged personal network; and
registering the merged personal network on a personal network server.

2. The method according to claim 1, further comprising: after the triggering a personal-network merging,
sending, by a personal network gateway or a personal network device in a personal network that is triggered to initiate the merging, a personal-network-merging request to a personal network gateway of another personal network to invite the another personal network to merge; returning, by the personal network gateway that receives the personal-network-merging request, to the personal network gateway or the personal network device that initiates the invitation a response indicating whether the another personal network agrees to merge, wherein
when the triggering a personal-network merging is initiated by the user or the server, then by default each device to be involved in the merging agrees to merge.

3. The method according to claim 1, wherein the selecting a new personal network gateway for a merged personal network from all members of two or more personal networks before the merging is: selecting the new personal network gateway for the merged personal network from personal network gateways of the two or more personal networks before the merging.

4. The method according to claim 1, wherein the enrolling a personal network device in the merged personal network comprises:
when the new personal network gateway after the merging and the personal network device belong to a same personal network before the merging, and the new personal network gateway is also the personal network gateway of the same personal network before the merging, then the personal network device already belongs to the merged personal network and is spared from being re-enrolled in the merged personal network; or
when the new personal network gateway after the merging and the personal network device don't belong to a same personal network before the merging, then the personal network device needs to send the new personal network gateway after the merging a request for being enrolled in the merged personal network.

5. The method according to claim 1, wherein the registering the merged personal network on a personal network server comprises:
registering, by the new personal network gateway after the merging, the merged personal network on the personal network server; and storing, by the personal network server, information on the merged personal network.

6. An apparatus for personal-network merging located in a personal network gateway, the apparatus comprising a merging triggering unit, a gateway selecting unit, and a post-merging enrolling unit, wherein
the merging triggering unit is configured to trigger a personal-network merging by a user, a server, a service, a personal network device, a personal network gateway, or a particular event;
the gateway selecting unit is configured to select a new personal network gateway for a merged personal network from all members of two or more personal networks before the merging; and
the post-merging enrolling unit is configured to enroll a personal network device in the merged personal network.

7. The apparatus according to claim 6, further comprising
a merging responding unit configured to, when the personal-network merging is triggered, cause a personal network gateway or a personal network device in a personal network that is triggered to initiate the merging to send a personal-network-merging request to a respective personal network gateway of another personal network to invite the another personal network to merge, and cause the respective personal network gateway that receives the personal-network-merging request to return to the personal network gateway or the personal network device that initiates the invitation a response indicating whether the another personal network agrees to merge, wherein
when the triggering of the personal-network merging is initiated by the user or the server, then by default each device to be involved in the merging agrees to merge.

8. An apparatus for personal-network merging located in a personal network server, the apparatus comprising a merging triggering unit, a gateway selecting unit, a post-merging enrolling unit, and a first registering unit, wherein
the merging triggering unit is configured to trigger a personal-network merging by a user, a server, a service, a personal network device, a personal network gateway, or a particular event;
the gateway selecting unit is configured to select a new personal network gateway for a merged personal network from all members of two or more personal networks before the merging;
the post-merging enrolling unit is configured to enroll a personal network device in the merged personal network; and
the first registering unit is configured to register the merged personal network on the personal network server.

9. A method for personal-network splitting, comprising:
triggering a personal-network splitting by a user, a server, a service, a personal network device, a personal network gateway, or a particular event;
selecting a new personal network gateway for a personal network after the splitting from all members of a personal network before the splitting;
enrolling personal network devices in personal networks after the splitting, respectively; and
registering the personal networks after the splitting on a personal network server.

10. The method according to claim 9, further comprising: after the triggering a personal-network splitting,
sending, by the personal network gateway or a personal network device in the personal network that is triggered to initiate the splitting, a personal network splitting request to another respective selected personal network gateway of a personal network after the splitting; returning, by the selected personal network gateway that receives the personal network splitting request, to the personal network gateway or the personal network device that initiates the splitting request a response indicating whether to agree to split, wherein
when the triggering a personal-network splitting is initiated by the user or the server, then by default each device to be involved in the splitting agrees to split.

11. The method according to claim 9, wherein the enrolling personal network devices in personal networks after the splitting, respectively comprises:
when a personal network device to be enrolled in a personal network after the splitting and the new personal network gateway of the personal network after the splitting belong to a same personal network before the splitting, and the new personal network gateway is also the personal network gateway of the personal network before the splitting, then the personal network device already belongs to the personal network after the splitting and is spared from being re-enrolled in the personal network after the splitting; or
when a personal network device to be enrolled in a personal network after the splitting and the new personal network gateway of the personal network after the splitting don't belong to a same personal network before the splitting, then the personal network device needs to send the new personal network gateway after the splitting a request for being enrolled in the personal network after the splitting.

12. The method according to claim 9, wherein the registering the personal networks after the splitting on a personal network server comprises:
registering, by a new personal network gateway of a personal network after the splitting, the personal network after the splitting on the personal network server; and
storing, by the personal network server, information on the personal network after the splitting.

13. An apparatus for personal-network splitting located in a personal network gateway, the apparatus comprising a splitting triggering unit, a gateway selecting unit, and a post-splitting enrolling unit, wherein
the splitting triggering unit is configured to trigger a personal-network splitting by a user, a server, a service, a personal network device, a personal network gateway, or a particular event;
the gateway selecting unit is configured to select a new personal network gateway for a personal network after the splitting, including selecting the new personal network gateway after the splitting from all members of a personal network before the splitting;
the post-splitting enrolling unit is configured to enroll personal network devices in personal networks after the splitting, respectively.

14. The apparatus according to claim 13, further comprising a splitting responding unit configured to, when the personal-network splitting is triggered, cause the personal network gateway or a personal network device in the personal network that is triggered to initiate the splitting to send a personal network splitting request to another respective selected personal network gateway of a personal network after the splitting, and cause the another respective selected personal network gateway that receives the personal network splitting request to return to the personal network gateway or the personal network device that initiates the splitting request a response indicating whether to agree to split, wherein when the triggering of the personal-network splitting is initiated by the user or the server, then by default each device to be involved in the splitting agrees to split.

15. An apparatus for personal-network splitting located in a personal network server, the apparatus comprising a splitting triggering unit, a gateway selecting unit, a post-splitting enrolling unit, and a second registering unit, wherein
the splitting triggering unit is configured to trigger a personal-network splitting by a user, a server, a service, a personal network device, a personal network gateway, or a particular event;
the gateway selecting unit is configured to select a new personal network gateway for a personal network after the splitting, including selecting the new personal network gateway after the splitting from all members of a personal network before the splitting;
the post-splitting enrolling unit is configured to enroll personal network devices in personal networks after the splitting, respectively; and
the second registering unit is configured to register the personal networks after the splitting on the personal network server.

16. The method according to claim 2, wherein the selecting a new personal network gateway for a merged personal network from all members of two or more personal networks before the merging is: selecting the new personal network gateway for the merged personal network from personal network gateways of the two or more personal networks before the merging.

17. The method according to claim 2, wherein the enrolling a personal network device in the merged personal network comprises:
when the new personal network gateway after the merging and the personal network device belong to a same personal network before the merging, and the new personal network gateway is also the personal network gateway of the same personal network before the merging, then the personal network device already belongs to the merged personal network and is spared from being re-enrolled in the merged personal network; or
when the new personal network gateway after the merging and the personal network device don't belong to a same personal network before the merging, then the personal network device needs to send the new personal network gateway after the merging a request for being enrolled in the merged personal network.

18. The method according to claim 2, wherein the registering the merged personal network on a personal network server comprises:
registering, by the new personal network gateway after the merging, the merged personal network on the personal network server; and storing, by the personal network server, information on the merged personal network.

19. The method according to claim 10, wherein the enrolling personal network devices in personal networks after the splitting, respectively comprises:
when a personal network device to be enrolled in a personal network after the splitting and the new personal network gateway of the personal network after the splitting belong to a same personal network before the splitting, and the new personal network gateway is also the personal network gateway of the personal network before the splitting, then the personal network device already belongs to the personal network after the splitting and is spared from being re-enrolled in the personal network after the splitting; or
when a personal network device to be enrolled in a personal network after the splitting and the new personal network gateway of the personal network after the splitting don't belong to a same personal network before the splitting, then the personal network device needs to send the new personal network gateway after the splitting a request for being enrolled in the personal network after the splitting.

20. The method according to claim 10, wherein the registering the personal networks after the splitting on a personal network server comprises:
registering, by a new personal network gateway of a personal network after the splitting, the personal network after the splitting on the personal network server; and storing, by the personal network server, information on the personal network after the splitting.
